(19) United States
(12) Patent Application Publication
(10) Pub. No.: US 2023/0198855 A1
(43) Pub. Date: Jun. 22, 2023

(54) DEPLOYING AND UPDATING MACHINE LEARNING MODELS OVER A COMMUNICATION NETWORK

(71) Applicant: Hughes Network Systems, LLC, Germantown, MD (US)

(72) Inventors: Venkat Ganesan, Germantown, MD (US); Kaustubh Jain, McLean, VA (US); Eddie Beal, Germantown, MD (US); Krishna Samavedam, Rockville, MD (US)

(21) Appl. No.: 17/555,055

(22) Filed: Dec. 17, 2021

(51) Int. Cl. H04L 41/14; G06N 20/00; H04L 41/142

(52) U.S. Cl. CPC H04L 41/145; G06N 20/00; H04L 41/142

(57) ABSTRACT

Systems, methods, and apparatus, including computer-readable media, for deploying and updating machine learning models over a communication network. In some implementations, a system receives log data from a plurality of devices in a communication network. Each of the plurality of devices stores a local copy of a machine learning model and uses the machine learning model to manage network traffic at the device. The system trains the machine learning model based on the received log data to change parameters of the machine learning model, for example, to more accurately predict a network traffic management parameter in response to receiving input indicating characteristics of the network traffic flows. The system broadcasts an update for the machine learning model to the plurality of devices using a multicast transmission, with the update being based on the changed parameters of the machine learning model.

### BACKGROUND

This application relates to deploying and updating machine learning models over a communication network.

Machine learning models are increasingly being used in many computerized systems. Machine learning models provide many advantages, including the ability to model very complex situations and make accurate predictions to address many different problems. For example, some models are used as classifiers to categorize a set of data. Other models are used to predict the current or future state of a device or system. Although machine learning models are powerful tools, they depend greatly on the amount and quality of training data used to train them. Even well-trained models often have difficulty providing accurate results for situations that were not sufficiently represented in training data or which occur for the first time after a model is trained. As a result, even a highly-trained, well-designed model may need to be updated or changed from time to time, especially as the contexts and situations in which it is used shift over time.

### SUMMARY

In some implementations, edge devices in a communication network may each store and use machine learning models that facilitate aspects of network communication. In a satellite network, satellite terminals may each use a machine learning model to assess the characteristics of network traffic or to predict an appropriate parameter to use in communication. As an example, a model at each satellite terminal can be configured to estimate a quality of experience being provided to a user. For example, the model can be configured to receive input about network traffic through a terminal and provide as output an estimate the quality of experience that a user perceives during a streaming media transfer, e.g., high quality with consistent transfers, medium quality with variability but few interruptions if any, low quality where interruptions or buffering likely impede consumption of the media, and so on. Other types of machine learning models can also be used in satellite terminals and other edge devices, for example, models to classify traffic into quality of service (QoS) classes, to classify the source or type traffic, to manage resources or predict configurations, etc.

In many cases, machine learning models used at edge devices need to be updated periodically. For example, for a model that predicts the quality of experience for streaming media transfers, the nature of typical traffic can change significantly over time. Users may begin to use new applications or websites, and existing websites and applications are often updated in ways that change how network traffic flows. In addition, the underlying codecs used may change, and traffic flows may be altered as different compression, resolution, or other parameters are used. Due to the often-changing nature of protocols used on the Internet, frequent adjustment of the models is often needed in a typical Internet Service Provider (ISP) network. The techniques discussed herein allow for frequent training of new models (whether as entirely new models or as updates to existing models) and distribution of the models to edge devices in a satellite-based ISP network.

The present document describes a system that can update the machine learning models of edge devices frequently and with minimal impact on user experience. Through ongoing updating of the models, the system can ensure that the models at edge devices perform as accurately as possible, even as the characteristics of traffic flows vary. The updating may be done in a series of update cycles, where each cycle includes capturing network traffic data from edge devices, processing the traffic data at a central server to update the model, and then providing an updated model back to the edge devices. To perform the updates, the system can capture examples of traffic flows of interest, e.g., statistics regarding for various types or sources of streaming media, as well as measures of user experience or other outcomes to be predicted. The training data can be collected by various representative edge devices and sent to a centralized server for processing. The server then uses the collected data to generate updated models that are trained on the latest traffic patterns of the network. The server optimizes the model, such as by compressing the model to fit within the computational constraints of the edge device. The models are then distributed back to the edge devices for each edge device to use in monitoring and managing network traffic.

The system can be configured to perform updates to machine learning models over a satellite communication link efficiently and with minimal impact to user data traffic. Newly trained models can be efficiently distributed to the edge devices by utilizing a file distribution protocol that minimizes bandwidth usage by leveraging the broadcast nature of the forward path of the satellite link. For example, model updates can be sent using a multicast transmission, in which multiple edge devices all receive the model update simultaneously through transmissions in the same time slots. Transmitting model updates in this manner minimizes the amount of time and frequency resources that are required to carry out a model update, leaving more time for transferring user data. The broadcast transmissions of model updates may occur in a portion of the frame structure that is designated for system maintenance or in another portion of the frame structure, where time division multiplexing (TDM), is used on the outroute to provide data from a gateway to terminals.

The manner that model updates are sent and the configurations of the edge devices themselves can also facilitate an efficient model update process. For example, satellite terminals can be configured to store and use machine learning models as data files that are separate from software, firmware, and other executable code. As a result, the software running on the terminals can be configured to allow the file(s) of the machine learning model to be updated or replaced while the terminal is running, without needing to terminate or reboot the software on the terminal that makes use of the machine learning model. With the model structured to be separate and independent from the executable software of the terminal (e.g., as opposed to embedding it into the software package), the terminal can seamlessly update the model without an accompanying reset to the terminal. When the server sends a new model or a model update, software in the terminal detects that the update to the model is being provided and saves the updated model as a data file with the appropriate characteristics (e.g., storage location, file name, metadata, etc.). The software in the terminal is configured to detect changes in the model (e.g., a change in version number, addition of a file in a particular folder for models, etc.), and so the software recognizes the availability of the new model and immediately puts it into use. This enables the system to minimize or completely avoid any interruption to the user traffic.

In some implementations, the transmitted model or model update includes more than simply the machine learning model (e.g., neural network, classifier, etc.) itself. For example, the transmission of a model or model update can include interpretable code, parameter values, logic, instructions, and other elements associated with the model. These additional elements can instruct or assist the receiving terminal to employ the new model. For example, the additional elements accompanying the model itself can include instructions that when interpreted apply the model to a record or set of values, rules for processing output of the model, specifications of the types and order of input values provided to the model, indications of the meaning of different outputs of the model, and so on. As a result, the model file or a model update can include the parameters of the model itself, integrated with the supporting logic, interpretable code, and configuration parameters to enable the existing software of the terminal to use the changed model. This can be particularly significant in cases where the change to a model alters the set of inputs to be provided to the model or the set of outputs provided by the model. As another example, the model file can be structured as a interpretable module, so that an interpreter already present in the terminal can interpret the model file to perform the operations needed to perform an inference with the new model on a record and to obtain an output in the form needed by the terminal's software (e.g., a classification label, a regression score, etc.). To enable this, the model file can incorporate the model parameters and model structure, as well as specify operations to perform in order to perform the inference processing using the model and the logic to convert or transform outputs of the model to a form expected by the terminal software (e.g., evaluate model outputs, apply thresholds, select a most likely classification, etc.). The model file can be structured so that interpreting the model file acts on input values provided as parameters for the execution of the model. For example, the interpretable process can receive input values that are values to provide to the model, or values from which model inputs are derived, or a pointer or link to a record where those values can be accessed. Thus, the model file or model update can be a self-contained interpretable or executable module containing the model and any supporting logic so that running the module with a set of input values performs a machine learning inference based on those input values and provides an output in a predetermined format expected by the terminal's software.

The ability to update machine learning models quickly and independently of the core software of a satellite terminal is a significant advantage. Software for embedded devices, such as a very small aperture terminal (VSAT) or other consumer premises equipment (CPE), are usually monolithic packages that cannot be updated while concurrently providing service. As a result, even small changes in the software often need to be pushed as a new software package, which requires a software update and a reset cycle with the accompanying interruption of service. The software update mechanism is costly in terms of maintaining releases, regression testing, as well as pushing the software updates to terminals over the satellite network link. Naturally, an update that changes the software not only makes the software unusable during the update but also risks compromising the function of the device generally if, for example, the software update process introduces errors or is interrupted and is not completed successfully. Updating the machine learning model separately from the software of the device allows model updates to be done with much lower processing overhead and without the risks that accompany altering the software of the device.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1C illustrate an example of a system for deploying and updating machine learning models in a communication network.

FIGS. 2A-2D illustrate another example of a system for deploying and updating machine learning models in a communication network.

Like reference numbers and designations in the various drawings indicate like elements.

### DETAILED DESCRIPTION

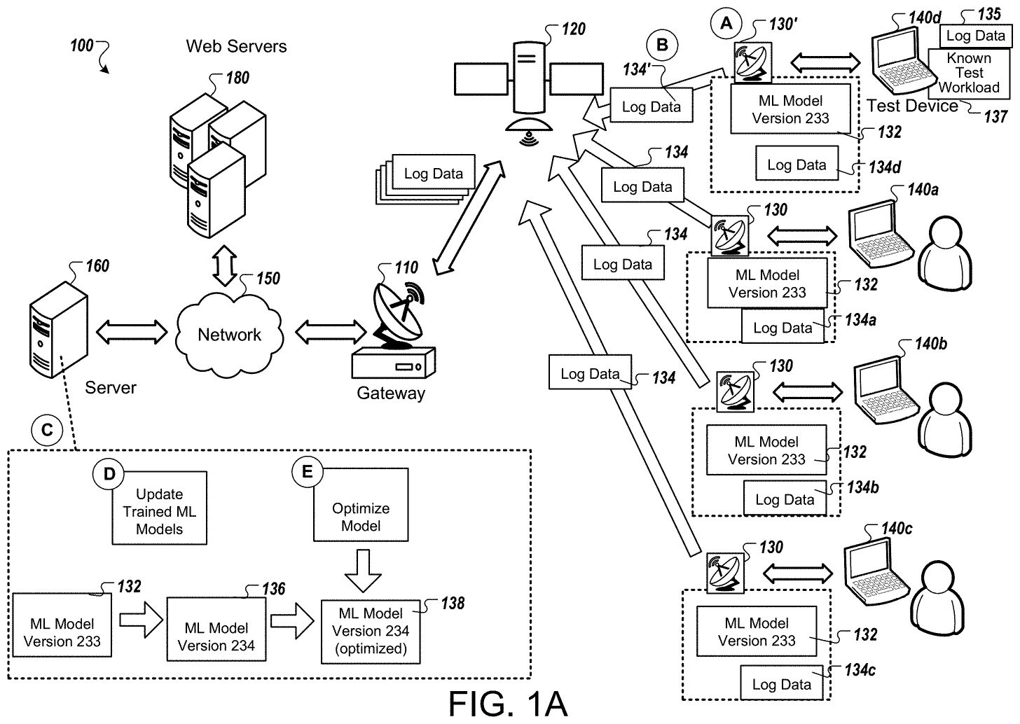

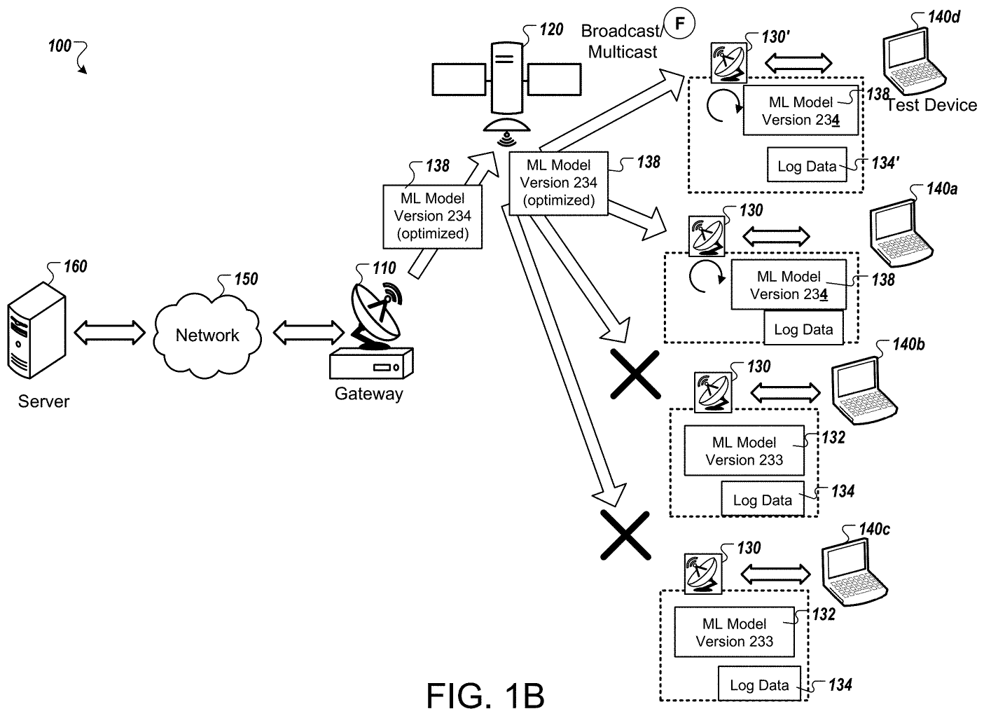

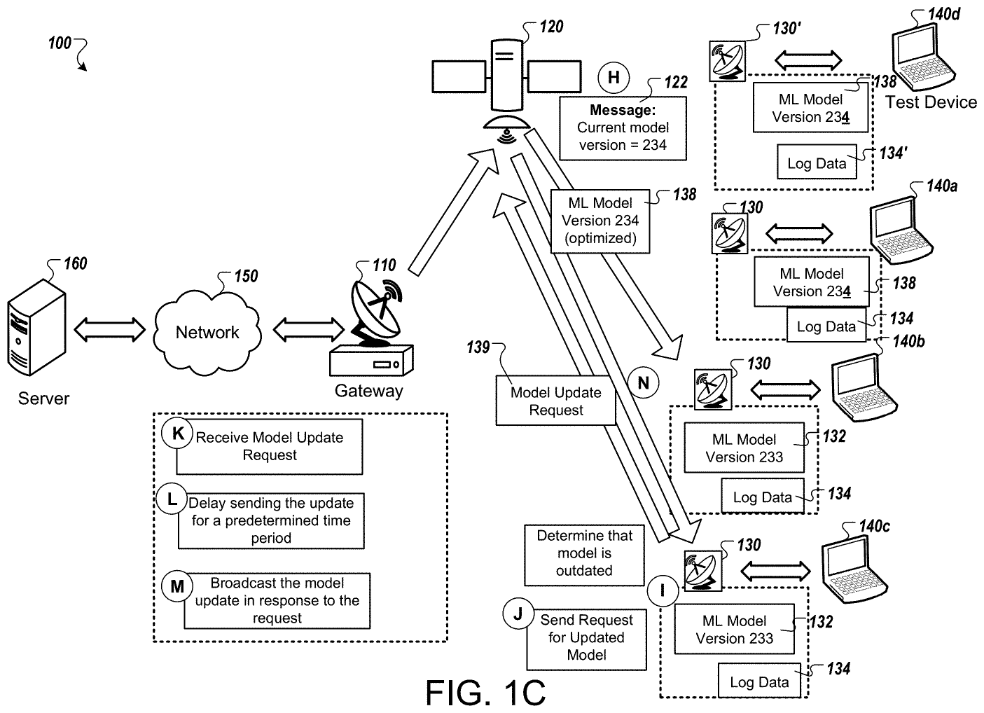

FIGS. 1A-1C illustrate an example of a system 100 for deploying and updating machine learning models in a network. The example of FIGS. 1A-1C shows a satellite communication system, but the techniques may be applied in other communication systems. For example, the techniques disclose can be applied to monitor and update edge devices for terrestrial, wireless, or wireline networks, for consumer or enterprise ISPs, etc.

The system 100 includes a gateway 110 that communicates with a satellite 120, and the satellite 120 communicates with various terminals 130, e.g. VSATs. Each of the terminals 130 can be provide a network connection to one or more client devices 140a-140c, such as phones, laptop computers, desktop computers, televisions, Internet of Things (loT) devices, and so on. The satellite 120 may further communicate with one or more test terminals 130′ in communication with one or more test devices 140d. As discussed further below, the traffic through the test terminals 130′ can be created in a known manner so that the test terminals 130′ experience and measure properties of known types of traffic. This generates monitoring data for known situations of interest, where the resulting traffic patterns have known classifications that can then be used as labels for training data to train machine learning models. The terminals 130 and the test terminals 130′ are configured at the edges of the network connection and close to the end users, and thus may be categorized as network edge devices.

The satellite 120 and the gateway 110 (along with potentially other network components) cooperate to transfer data to and from the terminals 130 to a communication network 150, e.g., a core network, the Internet, etc. The network 150 may be an Internet Service Provider (ISP) network that provides access to the Internet and may be connected to one or more web servers 160. The client devices 140a-140c and the test devices 140d may make use of the network connections that the terminals 130 and the test terminals 130′ provide through the satellite 120 and the gateway 110.

In the example shown in FIGS. 1A-1C, the terminals 130 and 130′ are configured to use trained machine learning (ML) models to enhance network communication operations. Deploying ML models at edge devices, such as at the terminals 130 and 130′, provides many benefits when compared to running the ML inference processing at a central server or across multiple servers in the cloud. Some of the benefits include reduced latency (e.g., immediate ML inference at the device where the inference is used, avoiding round-trip delays for communication with a remote server), reduced network traffic load (e.g., by avoiding the need to (i) upload input data for the model to the server and (ii) to download the results to the edge devices), privacy (e.g., by keeping the user traffic local), and the ability to deploy customized ML models targeted for different contexts (e.g., using models optimized for individual consumers or a group of consumers, grouped based on criteria such as location, service plan, etc.).

Machine learning models can be deployed in ISP networks to predict the end-user's quality of experience (QoE) by analyzing the user's traffic characteristics. For example, each of the terminals 130 and 130′ can store and use a trained machine learning model for QoE prediction for video streaming traffic flows. The models may be run in real time at each edge device, to predict the current QoE associated with the edge device (e.g., for a terminal based on the experience at one or more devices using the network connection the terminal provides). Running the model in the edge device improves the latency between initiating the request and getting the prediction. Running the model in the edge device also improves scalability. As an alternative, however, in some implementations, edge devices may be configured to forward the feature values for model input (e.g., network traffic statistics or other measurements), to a central server, which in turn runs the model to generate predictions on behalf of the edge device then sends the results to the device.

Many edge devices lack the computational resources required to perform the inference processing that a state-of-the-art machine learning model would require. To compensate for the lack of compute resources, the model itself can be compressed, which reduced model size, number of parameters, and the number of operations needed, and thus the compressed model can fit the available compute resources of the edge device. Additionally, the protocols used on the Internet for different transfers and activities, such as for video streaming, are ever-changing. To meet these challenges and provide more accurate inference processing, the models need to be periodically refined and re-distributed to the edge devices. The system 100 addresses these challenges with new techniques for generating and routing the data required for model refinement, as well as improved techniques for distributing the refined model to the edge devices in satellite-based ISP networks.

Using ML models at edge devices comes with certain challenges, and the system 100 is designed to address and minimize these challenges. For example, edge devices often have limited computational resources, and software is often difficult to deploy and update on embedded devices. The typical mechanisms for performing general software updates to edge devices in a satellite network also provide inefficiencies, including relatively large data transfers to receive the software update and interruption of network service to install the software updates.

In further detail, some of the challenges in making updates to edge devices are a result of the limited resources of the terminals 130 and 130′ (e.g., limited computational resources, limited data storage space, etc.). Network edge devices such as a consumer premise equipment (CPE) are usually embedded devices running a specific set of network services. Since the devices are running a small set of pre-designed applications, they are typically fitted with minimal hardware resources to keep the cost low. There can be other reasons for limited resources of embedded devices in other scenarios, for example, limited power supply, limited form-factor, etc. But, irrespective of the specific reasons for the constraints, hardware-constrained embedded devices generally require optimized firmware and software. Typically, the software for such embedded devices are developed as a monolithic architecture. This allows for easier optimization of the software stack to minimize the storage and compute utilization.

Other challenges in making updates at edge devices are related to the mechanism of deploying, maintaining, and updating software in edge devices. Because the core functionality of network services does not change often, there are typically very infrequent updates to the edge device software. Software updates are also preferably avoided because installing software update usually requires interrupting service provided by those devices. These problems are exacerbated for satellite networks where the CPE devices are satellite VSATs, which are typically located at remote locations that are difficult to reach and service. These challenges, and the potential for long-duration outages in cases of failed updates, make the software update cycle even costlier and slower for satellite network terminals.

ML components running on remote edge devices may need more frequent updates than those of other systems, depending upon the function of the ML models. Many current ML applications at the network edge are related to consumer use cases. For example, some of the target applications for the system 100 shown in FIG. 1 use ML models to analyze user traffic, in order to perform traffic classification (e.g., to assign packets or streams to appropriate QoS classes for prioritization) and user QoE estimation (e.g., estimating the level quality experienced for streaming video). In these applications, the ML models need to adapt quickly and repeatedly due to the fast-changing nature of consumer applications. For example, users preferences for applications and websites change frequently (e.g., from Facebook, to Snapchat, to Tiktok, etc.). Even when applications that consistently have heavy traffic are subject to updates that change how data transfers are made (e.g., newer and better video codecs and other streaming mechanisms for video streaming apps such as Netflix, YouTube, etc.). ML models trained using example data for older user applications may have reduced performance on newer applications, because differences in the traffic patterns the different versions create may result in misclassification.

For example, a model can be configured to classify user traffic into a fixed set of classes (e.g., interactive traffic for web pages, media streaming traffic, bulk file transfer, etc.). ML models that perform traffic classification on the edge devices may need to be updated to handle the changing traffic characteristics of existing apps or to handle newer apps, including user apps or even Internet of Things (IoT) applications. Similarly, ML models that perform QoE estimation, such as to estimate QoE for video streaming, may need to be updated to handle updates to video streaming user apps (e.g., changes to the Netflix application) or even changes to underlying codecs (e.g., enhanced video & audio codecs with better compression or higher resolution), etc.

Due to the fast-changing nature of these user applications, the ML components on the edge devices need to be frequently updated as well. In particular, edge devices benefit from an agile mechanism for updating ML components which can be decoupled from the usual device software updates. The system 100 in FIG. 1 provides a solution in which ML components (e.g., model updates) can be pushed to edge devices with lower bandwidth cost and with lower disruption compared to traditional software updates. The update mechanism may utilize software download (SDL) channels to enable seamless ML model updates. In some cases, the ML model update can be sent as a transmission of configuration data, rather than a full software update. Thus, the ML component updates may not require a reset cycle and so avoid downtime of network infrastructure elements such as a satellite terminal. Depending upon the ML component, the process of receiving, installing, and applying the update may not even result in any interruption to the user.

ML models are trained on example data, and the system 100 can obtain and use various types of training data. Many ML models are trained using examples of the type of data that would be provided as input when the ML models run inference processing. One significant source of training data that the system 100 can use is data from edge devices themselves. Edge devices that are deployed and in use by users (e.g., network service customers) can each generate data about the state of the device and the traffic characteristics observed and periodically upload the captured data to a server 160. This provides an ongoing stream of new observations that can be used to train new ML models based on traffic representative of current usage patterns. This type of data, generated by terminals about the network conditions observed, can be unlabeled data from the terminals 130 associated with client devices 140a-140c.

In addition to using unlabeled data, the server 160 can also obtain and use labelled data from test terminals 130′ associated with test devices 140d. For example, test terminals 130′ can be placed on the network, and associated devices can perform known operations so that the traffic patterns can be linked to the different applications, websites, tasks, or interactions that created those patterns. For example, a test device 140d connected to a network through a test terminal 130′ can be configured to perform a set of predetermined actions (e.g., starting a moving stream using a Netflix mobile application, playing a YouTube video in the Chrome browser of a laptop, etc.) that use the network connection. The test device 140d can simulate user actions to carry out various network types of network transfers. The actions of the test device 140d are controlled and known, and the timing of these actions are known (e.g., when each of various known streaming operations are started and ended). As a result, the server 160 can correlate the network traffic characteristics observed at the test terminal 130′ with the known operations or interactions that the test device 140d performed to cause those network traffic characteristics to occur. As a result, the server 160 can label the different examples of observed network traffic data from the test terminal 130′ with ground-truth classifications of what those sets of traffic data represent (e.g., as known from what is instructed and determined on the test device 140d). In addition, for QoE testing, the test device 140d can monitoring quality (e.g., detect frame skipping or other disruption of media playback, monitor video data buffer status, detect interruptions to network service, etc.) to be able to provide a measured or calculated level of QoE for different traffic patterns based on what would have been experienced by a user of the test device 140d. As a result, indications of QoE and other aspects that may be desirable to predict can be obtained using various tools or instrumented end-user devices (e.g., devices that track applications used and usage of those applications, or devices which instruct known applications and types of usage). These aspects enable the use of data for supervised, unsupervised, or semi-supervised machine learning.

The system 100 provides solutions that address the challenges of making remote updates, which will be discussed in detail below. Briefly, the implementation of the software architecture in the terminals 130 and 130′ decouples the ML model and the software to facilitate frequent updates with minimal disruption to service provided by the terminals 130 and 130′. The system 100 uses a model update mechanism that leverages broadcast (e.g., multicast) transmission to maximize the efficiency of the transmission (e.g., to provide model updates to as many terminals as possible with the least amount of network capacity used). This mechanism can include transferring the new model through an SDL channel, e.g., through a protocol that manages file transfer and file version control, and which can push updates of files via multicast to multiple devices that each need an updated version of the file. To capture data for further training the models, the system includes a data collection or telemetry aspect, provided through a data logger in the terminals 130 and 130′ that provides data over the network to a data collector in the gateway 110 or a server 160. The server 160 provides an ML pipeline for continual learning and model optimization that is then distributed to the edge devices to improve the accuracy of the models in those devices in an ongoing basis. This provides the system high responsiveness to changing user behavior and the changing traffic generated by applications and websites.

Referring still to FIGS. 1A-1C, these figures show a process of collecting training data, updating a ML model, broadcasting updates of that ML model, and efficiently handling requests for model updates. FIG. 1A illustrates how the terminals 130 and 130′ repeatedly generate log data 134 and 134′ about network traffic and provide the log data to the server 160, which uses the log data as training data to generate an updated machine learning model. FIG. 1B shows how the system 100 broadcasts the updated ML model efficiently to various terminals 130 and 130′, enabling the terminals to begin using the updated ML model without causing downtime in the network connections. FIG. 1C shows how the system 100 handles ML model updates for terminals 130 that did not receive the earlier broadcast, and can leverage multicast techniques to maximize efficiency of bandwidth usage to update multiple terminals to the latest version of the ML model. The example of performing ML model updates and deployment is discussed using various stages labeled (A) to (N) which represent a flow of data and can be performed in the order indicated or in another order.

As shown in FIG. 1A each of the terminals 130 and 130′ stores and runs a local copy of an ML model 132. In the example, each of the terminals 130 and 130′ begins with the same version of the ML model 132, e.g., “Version 233.” The ML model 132 may be a model that has been trained to predict a network traffic management parameter in response to receiving input indicating characteristics of the network traffic flows. Examples of network traffic management parameters include a quality of experience (QoE) score or classification for video streaming, a quality of service (QoS) class determination for network traffic, a traffic type classification for the network traffic flows, an application type identification (e.g., identification of a type of application that created certain network traffic flows), an anomaly detection result, and network traffic priority scores.

The server 160 is configured to perform training of ML models. The server 160 be the source of the trained model 132 as well as future updates or new models that can be distributed to each of the terminals 130 and 130′. The server 160 receives log data 134 and 134′ from many terminals 130 and 130′, and the server 160 uses the log data 134 and 134′ to train updated ML models.

As shown in FIG. 1A, in stage (A), the devices 140a-140d communicate over the communication network 150 using the network connections provided by their corresponding terminals 130, 130′. For example, the devices 140a-140d send information to and receive information from various web servers 180 over the satellite link. The terminals 130, 130′ each periodically record measures of network traffic and store it as log data 134, 134′. For example, the terminals 130, 130′ can measure network characteristics over time intervals of a predetermined size, such as 1 second, 5 seconds, 15 seconds, 1 minute, or some other duration. For at the end of each successive interval, the terminals 130, 130′ can record the network traffic statistics for that interval in the log data 134, 134′ and can begin measuring statistics for the next interval. As a result, the terminals 130, 130′ each record a series of log entries or records, each of which can include various measures of network traffic and network conditions, as discussed further below.

Each terminal 130 is shown transferring data from user devices, and each terminal 130 may transfer data from multiple devices (e.g., a smartphone, a laptop, a desktop computer, and two televisions) concurrently. The terminals 130 record information about the network traffic to and from the respective client devices 140a-140c as log data 134. The log data 134 may indicate characteristics of network traffic flows, such as network traffic statistics, observed by the terminals 130. Because the traffic through the terminals 130 is user-generated, the applications, websites, and user actions that create the traffic is generally not known.

In addition, one or more test devices 140d also communicate over the network through a test terminal 130′. The test terminal 130′ can be configured to operate in the same manner as the terminals 130. However, unlike the terminals 130, the test terminal 130′ carries traffic generated by one or more test devices 140d in a known manner. Each test terminal 130′ records information about the network traffic from and to the test devices 140d connected to it as log data 134′. For example, each of the test devices 140d may simulate user actions by performing a set of known requests or actions that induce different types of network traffic. For example, the test device 140d may run a preconfigured, known test workflow 137, such as a series of known network interactions or network transfers at a known timing (e.g., at time 1, load Google.com using the Chrome browser; at time 2, download a file from a particular URL using the same browser; at time 3, begin streaming a particular movie using the Netflix application; etc.). As a result, the data transferred over the test terminals 130′ corresponds to known types of traffic, or at least provides traffic resulting from a known set of tasks or simulated user actions. The known test workflows 137 that the various test devices 140d perform can be changed from time to time, for example, to involve different actions or tasks, to use different applications or web pages, to stream video with different settings, etc. The server 160 may direct changes to the test workflows 137 or distribute new workflows 137 and instructions to the test devices 140d over the network.

As the test devices 140d perform their known workflows 137, the test devices 140d monitor parameters that can be used to measure QoE or other parameters of interest. The test devices 140d generate their own set of log data 135 from that monitoring. For example, during a video streaming operation, the test device 140d can determine the resolution the application selected for video streaming, the current bit rate, the amount or consistency of advance buffered data, the amount and duration of interruptions in playback and times when then occur, and so on. The information captured at the test device 140d can include metrics for the type of output the ML model is designed to produce (e.g., QoE score or QoE classification), or the data from which that type of output can be calculated. For example, the test device 140d can capture video playback quality statistics (e.g., number of playback interruptions, duration of playback interruptions, amount of data buffered, latency to begin playback, times playback began and ended, video resolution or size supported, audio and/or video bit rate achieved, video frame rate, and so on). These video playback quality statistics can then be used by the test device 140d to calculate a QoE class or score to include in the log data 134′, or the video playback quality statistics can be provided to the server 160 to calculate the QoE class or score at the server 160.

The test devices 140d can be configured to record a variety of properties of the traffic at those devices 140d in log data 135, to facilitate labelling of the different instances of log data 134′ with measured network parameters besides QoE. These measures can include true application layer data, for example, HTTP object level statistics like duration of exchange, time to first byte, response time, request size, and response size for each object. For each connection, the test device 140d can capture a variable-sized sequence of feature vectors for each object, with size of the sequence being the number of objects exchanged in that connection or data flow.

The measurements of the test devices 140d, as well as the timing at which different tasks or portions of the predetermined workflow are performed by each test device 140d, can be recorded so the traffic types and QoE measures determined by the test device 140d can be correlated with the log data 134′ of the test terminal 130′. This way, the measures for QoE and other known characteristics (e.g., the application being used, the webpage being used, the resolution and other settings used for streaming, etc.) can be matched with the log data 134′ entries that show the network traffic conditions that accompanied them. In other words, the log data 134′ generated by the test terminal 130′ can have sets of measurements timestamped, and log data at the test device 140d can also store records of tasks performed, network characteristics observed, and quality of experience measures all associated with timestamps as well. The server 160 can match records of network traffic characteristics observed by the test terminal 130′ with the test device 140d records that are closest in time. The server 160 can then assign the information from the test device 140d (e.g., indicating the application, web page, QoE, task, etc. at the test device 140d) as labels for the corresponding portions of the log data 134′.

The test devices 140d may further make network performance measurements, such as obtaining QoE and QoS quantity and classification. The test devices 140d or the server 160 may derive ground-truth labels of the network traffic management parameters of interest based on the network requests or the simulated user actions which are known in advance and predictable for the test devices 140d, or network performance measurements of the test devices. Thus, both the input of the ML models and ground-truth labels representing the correct output that a ML model should produce are available for traffic patterns generated by the test devices 140d.

The log data 134, 134′ can include any of various types of information about network traffic at the terminals 130, 130′. The log data 134, 134′ typically does not include actual packets of data streams, but instead includes values (e.g., statistics, measures, etc.) derived from the data streams through the terminals 130, 130′. When possible, the terminals 130, 130′ capture application-level data and flow-level data, and also capture packet-level data. Application layer metrics can be estimated from the incoming traffic connections using TCP-layer statistics which can include packet-level information. In some implementations, metadata indicating IP address, domain name server (DNS) information, server name indication (SNI), hostname or fully qualified domain name (FQDN), protocol used, etc. can be captured. As more and more systems encrypt traffic, these elements may not always be available. As a result, a number of payload-independent features can be extracted from the Internet Protocol (IP) traffic flow. A few examples include packet-level statistics, such as frequency and consistency of packet transmissions and amounts of packets in a flow. Various packet-level measures can be determined, such as packet sizes, packet arrival times, packet inter-arrival times, amount and frequency of packet traffic, byte frequencies, occurrence of bit patterns for different protocols, packet header characteristics, and so on. Packet content inspection can be performed in some implementations. In some implementations, a terminal can estimate or derive application-layer metrics using TCP state machine statistics for a TCP connection. This can be done by analyzing the sequence of requests from the client device 140a-140d and responses from the servers, the sizes of messages in packets and bytes, the relative timestamps, and so on. This yields more detailed information about object-level exchanges that happen over the connection or data flow.

In some cases, values of summary or aggregate features are stored in the log data 134, 134′. Examples of flow-level summary features about a connection include total number of packets, total response size, and so on. Collecting summary features is relatively easy, and the resulting models trained with summary features is small and can run on an embedded system without demanding excessive computational resources. More detailed metrics can be derived upon looking at inter-packet statistics like packet inter-arrival times, packet sizes (in both directions), time to first byte, and so on. All of these metrics may be determined at the packet level.

In stage (B), the terminals 130 and 130′ send collected log data 134 and 134′ over the network to the server 160. The server 160 does not need the log data to be provided in real time, and so the data can be collected in batches and sent at off-peak times or when network congestion is low. Alternatively, the terminals 130 and 130′ may periodically send out the log data with a predetermined schedule or frequency, or terminals 130, 130′ can send the log data after a particular amount of data or number of records is collected. In some implementations, the server 160 may request log data from the terminals 130, 130′ and the log data 134, 134′ is provided in response. The test devices 140d also send their log data 135, including network performance measurements and/or the ground-truth labels of the network traffic management parameter (e.g., a QoE score or class, or measurements from which one can be calculated), to the server 160 in a similar manner.

In stage (C), the server 160 receives the transmitted log data 134 and 134′ from the terminals 130 and 130′. The server 160 may also receive the log data 135 from the test devices 140d. From the received log data 134, 134′, and 135 the server 160 prepare training data to be used in training a ML model, e.g., by further training the ML model 132 or training a new model to be used in place of the ML model 132. Preparing the training data can include matching sets of traffic measures from the log data 134′ with the corresponding measures in the log data 135. This can be done by matching the time stamps of log data 135 entries with the closest time stamps of the log data 134′. The server 160 then uses the matched records to apply a training label, such as a QoE classification in or derived from a log data 135 record, to each set of network measures in the log data 134′.

Using the labeled training data generated using log data 134′, 135 from the test terminals 130′ and test devices 140d, the server 160 can also apply labels to the log data 134 that reflects user data through the terminals 130. The labeled data may indicate, for example, example data sets (e.g., sets of network traffic measures) that have been assigned to a first QoE class, example data sets that have been assigned to a second QoE class, example data sets that have been assigned to a third QoE class, and so on. With this information, the server 160 can use clustering techniques or regression analysis to identify the characteristics that are common among the examples for each QoE class (e.g., the patterns, commonalities, ranges of values, etc. that distinguish examples in one class from the others). In some cases, there may be multiple clusters identified for each QoE class depending on the characteristics of the examples. Once the clusters or characteristics of each QoE class are determined, the server 160 can evaluate the sets of network traffic measures in the log data 134 to assign them to the different clusters or groups. Each particular example in the log data 134 can be assigned to the cluster that includes examples most similar to the particular example. The examples in the log data 134 are then labelled with the QoE class for the cluster to which they have been assigned. This enables the server 160 to extend the ground-truth labels known for the smaller set of log data 134′ to label the log data 134 with labels that are most likely to be correct, without requiring manual analysis and labeling.

In stage (D), the server 160 updates the ML model 132 based on the log data 134 and 134′ to generate updated ML model 136. The server 160 also uses the labels applied, both the ground-truth labels of the network traffic management parameter obtained from the test devices 140d in the log data 135 and the labels generated for the test data 134. For example, the server 160 may train the ML model to generate a set of updated model parameter values for the updated ML model 136.

Any of a variety of ML model types may be used. For example, the ML model 132 may be a neural network, a support vector machine, a classifier, a regression model, a clustering model, a decision tree, a random forest model, a genetic algorithm, a generative adversarial network, a reinforcement learning model, a Bayesian model, or a Gaussian mixture model. The training process can be performed using iterative, incremental adjustments to the value of model parameters to shift the nature of inference predictions of the model toward the labeled data.

For example, in the case of a neural network model, backpropagation of error can be used to provide, to the model under training, an input vector having values derived from network traffic measures for a particular example. The model processes the input, propagating the data through the model at the current training state to obtain an output, which the server 160 compares with a target output that is based on the label for the example. The difference between the output and the target results in an error measure, which is used to adjust the values of parameters (e.g., node weights) in layers of the neural network in a manner that adjusts what the output would be and reduces the error that would occur. Over many training iterations with many different examples the model can be trained to make highly accurate predictions. As another example, for a random forest classifier, the server 160 can build multiple decision trees and merge them together to obtain a model with accurate and stable prediction.

The training process may alter various aspects of the ML model 132, and may refine or update the ML model 132 or generate an entirely new model. The model that is trained may have a different size or structure (e.g., number of neural network layers or number of nodes per layer). In some implementations, however, the size and type of inputs and outputs are preserved to facilitate integration of the new model with existing software of the terminals 130, 130′. For example, if the ML model 132 is configured to receive input of particular set of 50 input features and to provide output (e.g., a probability value) for each of 10 different QoE classes, then the newly trained ML model 136 that is produced may also have the same inputs and outputs, despite changes to the values of the model parameters and potentially the number and arrangement of those model parameters. This constraint can enable the new ML model 136 to be a “drop-in” replacement for the previous ML model 132, requiring no changes to the terminal software to generate input for the model 136 or to interpret output from the model 136.

In some implementations, the training of the machine learning model may include unsupervised training based on the log data 134, which includes characteristics of network traffic flows at the respective terminals 130 without ground-truth labels of the network traffic management parameter. The unsupervised training may include application of a clustering algorithm, an anomaly detection algorithm, or unsupervised neural-network processing.

The training of the ML model may include supervised training based on the characteristics of network traffic flows and corresponding ground-truth labels of the network traffic management parameter from the test terminals 130′ that are associated with the test devices 140d running the predetermined tasks. The supervised training may include determining training targets corresponding to instances of network traffic flows based on the predetermined tasks correlated with the network traffic flows, and using the training targets to update parameters of the machine learning model.

In some implementations, the training of the ML model includes semi-supervised training using both the unlabeled data and the labeled data. The semi-supervised training may use algorithms such as using generative models, low-density separation, or classification algorithms using a graph representation of data. The semi-supervised training may be further performed using metadata from the terminals 130 associated with the client devices 134a-134c.

In some implementations, the server 160 may update the ML model at a predetermined frequency (e.g., weekly, monthly, once every three months, or some other frequency) or on a predetermined schedule. In some implementations, the server 160 may update the ML model when it determines that an update is needed. For example, the server 160 may receive, in the log data 134, 134′ accompanying each example of network traffic conditions, outputs that ML model 132 generated at the terminals 130 and 130′. The server 160 can compare the ML model outputs actually generated for an example with the labels applied to the example in processing the log data 134. Based on the comparisons, the server 160 can determine when a level of accuracy falls below a threshold (e.g., the rate of errors for examples received in a time period exceeds a threshold) and as a result determine to update the ML model as a result. Once the server 160 determines that an update to the ML model 132 is needed or an aspect of the ML model 132 is to be updated, the server 160 may update the ML model parameters based on most recent received examples.

Optionally, in stage (E), the server 160 may perform an optimization process to reduce complexity of the newly trained ML model 136. For example, the server 160 may perform the optimization process based on known capabilities of the terminals 130 and 130′, status of the terminals 130 and 130′, or the characteristics of the network traffic flows. The optimization process may include model compression and complexity reduction of the ML model 136, so the optimized ML model 138 may run efficiently on the limited processing hardware of the terminals 130, 130′. For example, the optimization process may include quantizing parameter values of the machine learning model, truncating the parameter values of the machine learning model, reducing a number of parameters of the machine learning model, or compressing the machine learning model. According to some implementations, the optimization process may further include packaging data indicating a subset of the parameters of the updated model 136 (e.g., only parameters that have changed values) as an incremental partial update to the model 132, so that the update requires less bandwidth to transmit than the full model 136.

As shown in FIG. 1B, in stage (F), the server 160 provides the optimized ML model 138 to the gateway 110, which causes the satellite 120 to broadcast the optimized ML model 138 all terminals 130 and 130′ using a multicast transmission. In some implementations, the broadcasted update include updated values of model parameters of the machine learning model. For example, the broadcasted update includes the full new ML model 138 that includes values for all of the model parameters of the ML model 138. In some implementations, the broadcasted update includes a partial replacement model, having updated values for a subset of the model parameters of the ML model 138 that may overwrite only a portion of the earlier ML model 132 that was deployed.

In some implementations, the broadcasted update is transmitted to the terminals 130 and 130′ over a file transfer mechanism, such as one configured to transfer provide configuration settings, software, or firmware to the terminals, such as software download (SDL) channels. The ML model update, upon being received by the terminals 130 and 130′, enables the terminals 130, 130′ to transition from using the previous version of the ML model 132 to using the updated version of the ML model 138 without interrupting network traffic at the terminals 130, 130′. In some implementations, the satellite 120 communicates with the terminals 130, 130′ using a time-division multiple access (TDMA) protocol, e.g., using TDM for the outroute (e.g., downlink providing data from the gateway to the terminals) and TDMA for the inroute (e.g., uplink from terminals to the gateway through the satellite). In this arrangement, terminals 130, 130′ are assigned different slots in a frame structure or are otherwise scheduled for specific intervals for upload and download. The broadcast of ML model updates can be scheduled so that many or even all terminals 130, 130′ are assigned to receive the ML model update in the same time slots. The terminals 130, 130′ can be notified in advance of the time slots designated for the model update, so each terminal 130, 130′ can receive and store the data for that update. As a result, a single transmission of the ML model 138 can be simultaneously received by many different terminals 130, 130′. This minimizes the amount of communication bandwidth used (e.g., amount of time on the frequency channel) that the system 100 uses, and is much more efficient that scheduling and transmitting to different terminals 130, 130′ individually in separate time slots. In many cases, the model 138 is broken into pieces for transmission at different times (e.g., interspersed with user traffic). The different pieces of the model 138 are provided in a numbered sequence, and terminals 130, 130′ can receive the pieces and combine them to obtain the full model 138.

In the example, all of the terminals 130, 130′ are assigned (e.g., scheduled) to receive the updated ML model 138 at the same time (e.g., in the same downlink time slot(s)), and are notified or instructed to receive and save the new ML model 138 provided at that time. Similarly, the transmission itself can have packet headers or other metadata that indicate the applicability of the transmission to all of the terminals 130, 130′. As illustrated, the terminals 130, 130′ that are connected to devices 140a, 140d successfully receive the ML model 138 in the broadcast transmission. However, not all of the terminals successfully receive the update in that transmission. The terminals 130 connected to the devices 140b, 140c do not successfully receive the ML model 138, which may be because at the time of the broadcast those terminals 130 were powered off, were experiencing high interference, or otherwise did not receive the update.

In stage (G), the terminals 130 and 130′ that received the updated model 138 make local updates and start using the new ML model 138 to predict the network traffic management parameter. This is shown in FIG. 1B as two terminals 130, 130′ changing from storing and running the earlier ML model 132 (“Version 233”) to instead storing and running the new ML model 138 (“Version 234”). The terminals that did not successfully receive the broadcasted model update continue to use the ML model 132 (“Version 233”) that they already had previously.

The network traffic management parameter that the new ML model 138 predicts can be the same type of parameter that the previous ML model 132 predicted. For example, the output of the ML model 138 can provide a QoE score or classification, a QoS classification for network traffic, identifiers for traffic types of the network traffic flows, identifiers for application types or media types, or indicators of anomalies in the network traffic flows.

As shown in FIG. 1C, in stage (H), the system 100 may periodically broadcast a version message 122 indicating the current (e.g., most recent) model version that has been distributed. As discussed above, some terminals 130 may not be connected and operating at the time the update is broadcasted, and so may not receive the updated ML model 138 when it is first broadcasted, or may receive only a portion of the ML model 138. Therefore, the system 100 may take additional steps to efficiently provide the updated ML model 138 that have not received it after it is first broadcasted.

This version message 122 can be sent in a portion of the communication frame structure (e.g., a TDM outroute) used for configuration or maintenance, in which all terminals 130, 130′ are configured to receive data and interpret the configuration information provided. The terminals 130, 130′ can receive the version message 122 that includes a model version number (e.g., “234” in the illustrated example). The terminals 130, 130′ then each compare the received version number with the version number for the locally stored model. The terminals 130, 130′ connected to the devices 140a, 140d make the comparison and determine that their model is up to date, since the received version number matches the version number of the locally stored ML model 138. However, the terminals 130 connected to the device 140b, 140c make the comparison and determine that they have an outdated model, since the received version number (e.g., “234”) is higher than the version number (e.g., “233”) of their stored model 132.

In stage (I), after some terminals 130 and 130′ have received the broadcasted version message 122, a particular terminal 130 connected to the device 140c determines, based on the version number in the model version message 122, that the stored model is not the current version of the model. As a result, in stage (J), the terminal 130 connected to the device 140c sends a request 139 for the updated version of the model 138 to the gateway 110 via the communication link through the satellite 120.

In stage (K), the gateway 110 receives the request 139 for the updated ML model 138 and schedules a new broadcast of the new ML model 138. The gateway 110 can assign appropriate time slots for the transmission, or may perform additional handshaking or notification to the terminal 130, so the terminal 130 opens the correct ports and listens for the update at the right time and channel.

In stage (L), the gateway 110 delays sending the broadcast of the new ML model 138 in response to the request 139. Rather than respond to the request 139 by sending the model 138 immediately, the gateway 110 can wait to receive requests for the model 138 from other terminals 130, 130′. In particular, the gateway 110 can wait and accumulate additional requests from other terminals 130, 130′ that also need the updated ML model 138. In some implementations, the gateway 110 waits until at least a minimum threshold number of requests are received from different terminals 130, 130′ and sends another broadcast of the ML model 138 once the threshold is reached. In other implementations, the gateway 110 may simply wait for a predetermined period of time, according to the scheduled time in stage (K). For example, the gateway 110 can schedule another broadcast of the ML model 138 for a time that is 15 minutes, an hour, a day, or some other predetermined amount of time after the request 139. As additional requests for the updated ML model 138 are received, the gateway 110 coordinates with the entire set of terminals 130, 130′ that have requested the new ML model 138 to prepare them to receive the upcoming broadcast. For example, the gateway 110 can notify each terminal that has requested the ML model 138 of the time of the upcoming broadcast, the ports to use to receive the ML model 138, and other parameters as needed.

In stage (M), the gateway 110 broadcasts the updated model 138 again, in response to the model update request 139 received from the terminal 130 associated with client device 140c. In stage (N), any terminals 130, 130′ that need the updated model 138 may receive the updated model 138 and apply the update. Terminals 130, 130′ that need the updated model 138 still can open the correct ports at the correct times to receive this additional broadcast, based on the data provided in advance by the gateway 110 over the satellite link.

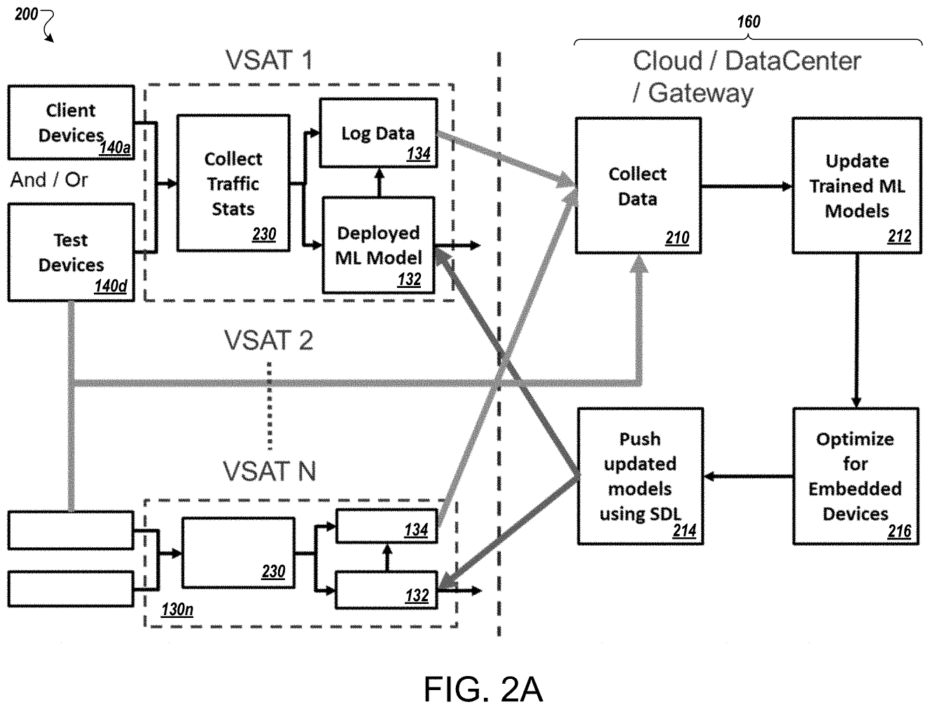

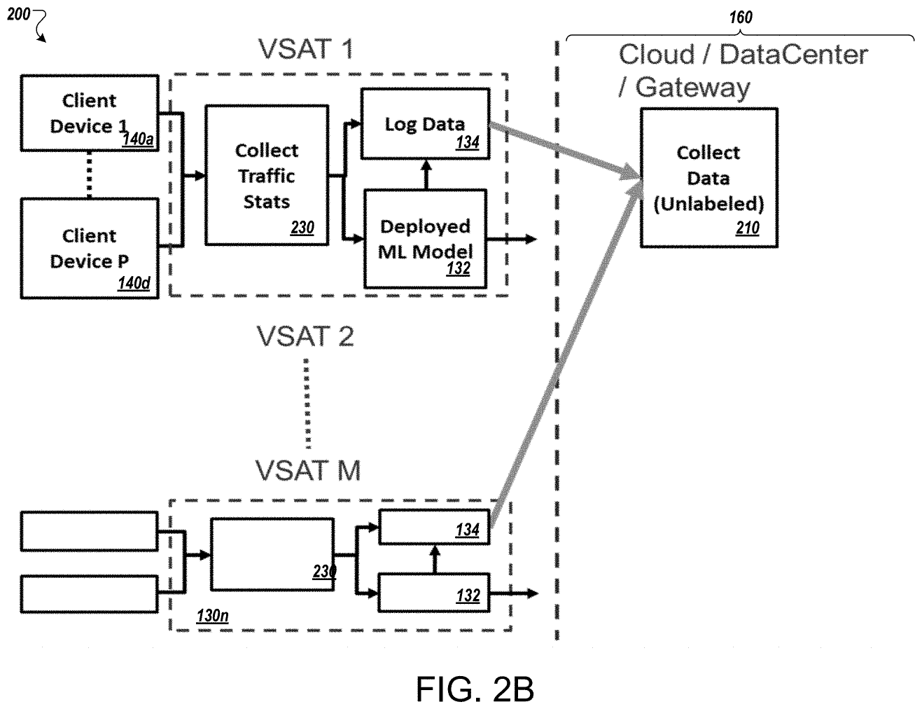

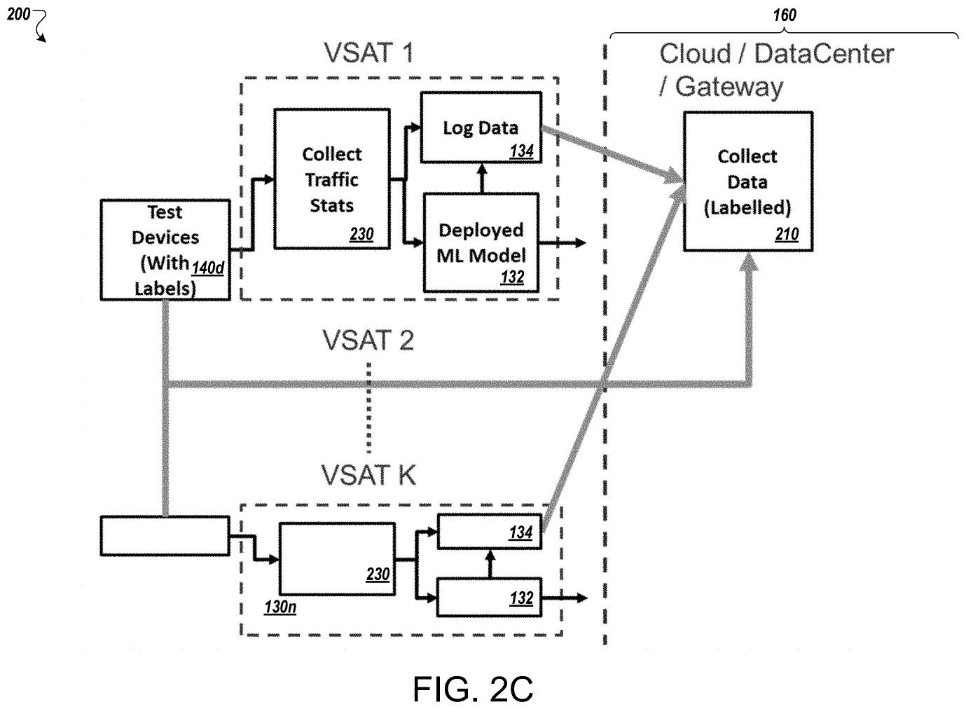

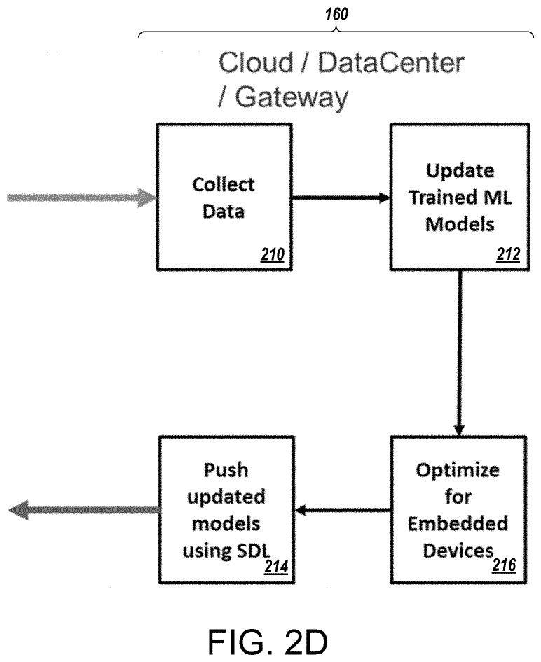

FIGS. 2A-2D illustrate a system 200 that further illustrates various principles of the techniques discussed above. FIG. 2A shows the overall system overview, where the focus is on ML models 132 running in the VSATs 130, 130′. The other components running at a more central location, e.g., the server 160, which are needed for model updates, are shown as well. Also shown are the client devices 140a or test devices 140d which generate the network traffic on which the ML models 132 are run. The relevant processes running in the VSAT/CPE terminals 130, 130′ are a network traffic statistics collector 230 and a deployed ML model 132 (e.g., an inference model). The terminals 130, 130′ also have a data logger, which logs the ML input and output data, for use in subsequent training and evaluation.

The user devices 140a (or test client devices 140d) are connected to the VSAT 130, 130′ and the VSAT communicates with the satellite 120 (FIGS. 1A-1C) and the gateway 110. The user traffic flows as shown in FIGS. 1A-1C. However, the FIGS. 2A-2D show the just components used to handle VSAT software updates and ML model updates. The server 160 includes modules to collect data 210, update trained ML models 212, to optimize the ML models for embedded devices 214, and network management tools 216 to handle configuration updates and software release updates. The management tools 216 pushes the updated ML models to the VSATs 130, 130′. These four blocks (e.g., elements 210, 212, 214, 216) can be at a satellite gateway 110, a central datacenter, or in a cloud computing system.

FIG. 2B shows data collection from terminals 130, 130′. Given the need for ML models 132 to be updated over time, one of the first aspects of the system 200 data collection. The ML models 132 are trained and evaluated on real user traffic to the extent possible. In addition to real user traffic, additional test traffic from controlled devices 140d can be used to collect labelled training data.

In many implementations, the ML model 132 is used in the communication network at MAC-layer, network-layer, or higher layer, targeted for certain services for efficient network resource monitoring and utilization. The functionality is typically handled by software code running on the CPU running an operating system such as embedded Linux. Processes for these applications can be in the kernel-space or user-space.

The ML model 132 and associated software can be developed in such a way that the necessary libraries are installed within the software release and so are the pre-processing steps for converting the unstructured data and converting it into input features of the ML model 132. The ML model 132 itself can be stored as a file in FlatBuffer format which can be updated independent of the core software binary for the terminals 130, 130′. Depending upon the ML model output, ML models can be updated (e.g., replacing/overwriting the model file) without requiring resetting the terminal 130, 130′ as is usually required for software updates for such devices or even without requiring a software process restart. The newer ML model is immediately applied to new network traffic as it comes in, without interrupting any user traffic or device processes.

In the terminals 130, 130′, libraries like Tensorflow Lite can be used with C++ bindings (or other appropriate languages) to run ML inference models. These libraries, with the basic support for running common inference models, can be complied in the software monolith and need not be updated often. The different ML inference models themselves can be given as code to be run by an interpreter, where the interpretable code can be easily swapped by just updating the model file. For example, model files in Tensorflow Lite can be provided in FlatBuffer format, which captures the required model parameters or computations to be performed in the deployable model. FlatBuffer is an efficient cross-platform serialization library, and FlatBuffer binary files can be used by the Tensorflow Lite interpreter. Hence, the ML models can be easily updated by simply updating (e.g., overwriting) the corresponding FlatBuffer model file.

In some implementations, the transmitted model file or model update includes more than simply the machine learning model (e.g., neural network, classifier, etc.) itself. For example, the transmission of a model or model update can include interpretable code, parameter values, logic, instructions, and other elements associated with the model. These additional elements can instruct or assist the receiving terminal to employ the new model. For example, the additional elements accompanying the model itself can include instructions that when interpreted apply the model to a record or set of values, rules for processing output of the model, specifications of the types and order of input values provided to the model, indications of the meaning of different outputs of the model, and so on. As a result, the model file or a model update can include the parameters of the model itself, integrated with the supporting logic, interpretable code, and configuration parameters to enable the existing software of the terminal to use the changed model. This can be particularly significant in cases where the change to a model alters the set of inputs to be provided to the model or the set of outputs provided by the model. As another example, the model file can be structured as a interpretable module, so that an interpreter already present in the terminal can interpret the model file to perform the operations needed to perform an inference with the new model on a record and to obtain an output in the form needed by the terminal's software (e.g., a classification label, a regression score, etc.). To enable this, the model file can incorporate the model parameters and model structure, as well as specify operations to perform in order to perform the inference processing using the model and the logic to convert or transform outputs of the model to a form expected by the terminal software (e.g., evaluate model outputs, apply thresholds, select a most likely classification, etc.). The model file can be structured so that interpreting the model file acts on input values provided as parameters for the execution of the model. For example, the interpretable process can receive input values that are values to provide to the model, or values from which model inputs are derived, or a pointer or link to a record where those values can be accessed. Thus, the model file or model update can be a self-contained interpretable or executable module containing the model and any supporting logic so that running the module with a set of input values performs a machine learning inference based on those input values and provides an output in a predetermined format expected by the terminal's software.

ML models 132 run inference processing (e.g., prediction) based on values of input features, and the ML models 132 give output indicating the desired output results (e.g., traffic class, QoE metric estimate, etc.). For training newer ML models 132, the system 200 collects input values for the types of input data that the ML models are designed to receive and process. Hence, the system 200 includes data loggers at the CPE/VSAT 130, 130′ to log the input features, and optionally the output of the ML models 132 running on the CPE. These input features are typically derived based on the user traffic (e.g., TCP/IP packets, TCP/UDP connections, domain names, etc.). At the terminals 130, 130′, user traffic is filtered and post-processed and converted to structured data from which the input features for the ML models are derived. One option is to log the exact input feature values (e.g., the input feature vectors) used as input to the ML model 132 at the terminals 130, 130′. However, this very specific set of information may limit the flexibility in use of the data to train future ML models, especially if the ML model structure changes in a way that uses a different set of input features. Similarly, updated filtering and post-processing of user traffic to derive modified input features might not be possible. Hence, the system preferably logs more generalizable data.

The system 200 can potentially log entire user traffic traces (e.g., using the tcpdump analyzer). However, this is often prohibitively large both to store locally and upload over the network to the central database. Hence the system 200 take an intermediate step of doing some basic filtering and compression of traffic statistics, before logging them at the VSAT 130, 130′ for collection by the server 160. For example, it can include logging summary statistics for each connection (e.g., source IP address, destination IP address, count of packets sent, count of packets received, average packet sizes, etc.). Other examples include features with higher-layer abstraction (e.g., application-level estimates) like the occurrence of HTTP(S) object requests and responses, and their timing and sizes. A variety of useful and concise data for traffic logs can be generated from traffic measurements or packet traces.

Since the system 200 might not need to collect data from all the user terminals, the system 200 have configurable parameters to enable/disable data logging, as well as limiting the amount of storage dedicated to storing network traffic statistics. These can be changed on the fly without impacting the VSAT terminal 130, 130′ or user traffic. However, the data filtering and logging components themselves can be included as part of the overall software binary and can be updated as part of the CPE firmware updates only. Hence, they need to be well designed to log the necessary input data even to accommodate and enable future changes to ML models 132.

Data collected from real consumer VSATs 130, 130′ is considered unlabeled data because the system 200 would not know the correct labels or ground truth of what type of application or transfer is running (e.g., for traffic classification) or what the user is actually experiencing (e.g., for QoE estimation). This unlabeled data is useful in unsupervised ML techniques or can be combined with other data sources to reasonably obtain the correct labels. However, this unlabeled data can be combined with labeled data from controlled experiments, thereby increasing the utility of both the unlabeled and labeled data sets. This can be achieved using a host of supervised and semi-supervised machine learning techniques.

FIG. 2C shows how the system 200 can obtain labels or ground truth information from instrumented test devices 140d. The system 200 can enable a data logger on the test VSATs/CPEs 130′ which are connected to test devices 140d running known traffic tests, e.g., known test workflows 137. The test devices 140d can be further instrumented to log the ground truth (e.g., decrypted traffic type, measured QoE metric) which is known to the client application on the test device 140d. Then the two sources can be appropriately combined using key identifiers including connection ID, connection 4-tuples (e.g., source and destination IP addresses and ports used), timestamps, etc. to correctly match network measures with the correct labels.

Typically, collecting labeled data from test terminals 130′ is costly and adds load on the real network. Hence, the amount of labeled data can be low. However, unlabeled data from user terminals 130 can be used to inform where to focus the efforts for collecting labeled data. Additional metadata can be logged in both cases for more informed experiments and evaluation.

The data that is logged in the VSATs 130, 130′ and test devices 140d is collected at a central database at the server 160. This labeled and unlabeled data can be then used for updating the ML models 132.

FIG. 2D shows the various components for updating the ML models. These can be run at one central server or in a distributed way at multiple servers. In addition, the update process shown can be performed separately for different groups of terminals 130, to customize the model features for the typical traffic of different groups or types of terminals 130. For example, data collection and model updates can be done separately for different groups of users, to generate different ML models (e.g., different model training states) for different geographical locations, or for different satellite gateways (e.g., with terminals using a particular gateway each receiving the model for that particular gateway).

The data collection module 210 is responsible for periodically pulling the logged data from the VSAT/CPE shown as terminals 130, 130′. The data collector 210 is further instrumented to collect the labels or other log data 135 from the test devices 140d. Thus the data collector 210 stores both the labeled and unlabeled data. The collected data is then used for training newer ML models. The collected data, including the metadata, and the difference in labeled and unlabeled data can also be analyzed separately. The server 160 can then use the information for future changes to test device setup to focus on under-served classes in labeled data. As discussed above, the server 160 can send updates to the test devices 140d to change the contents of tasks, actions, and network transfers to run in the test workflows 137.

Before triggering ML model retraining, performance of the existing ML model 132 can be evaluated using the labeled data. In other words, if no noticeable decline is performance is detected, subsequent model updates can be delayed until deemed necessary. For example, the ground-truth labels determined by test devices 140d and provided in log data 135 can be compared with calculated labels output by the ML models 132 in the test terminals 130′. When the rate of errors exceeds a threshold, this can trigger additional refinement training of the ML model 132. Alternately, the ML model training can be set up as online learning for repeated continual model updates, without a separate accuracy pre-check to evaluate current ML model performance. The continual update process can help in keeping up accuracy despite gradual changes in underlying traffic patterns.

The ML model training module 212 can perform the training needed to update parameters of the ML model 132. In most scenarios, ML model training is done at a central location and using high-performance hardware (using GPUs, TPUs, etc.) for faster training, as well as using tools such as PyTorch, Keras, Tensorflow, etc. The training can be performed with constraints based on the target device for running the inference models. If the models are solely targeted to run on embedded platform like the VSAT/CPE, then appropriate constraints can be imposed on the model architecture and weights while training. Techniques like quantization-aware training can be utilized to train and evaluate appropriately constrained models. In such cases, both the ML model performance is optimized, while trying to limit the resource utilization of the target devices (CPU, memory, storage, etc.). Alternately, training can be done independent of the target platform or device for running the inference models.

The model optimization module 214 can use techniques like post-training quantization to reduce the resource footprints of the ML models while ensuring minimal loss in model performance. Model converter software can be run to fit the model to the targeted edge device, e.g., the VSAT/CPE. These inference models can be the FlatBuffer file as described above. While the training for ML models can be done with the use of high-level tools, using high-precision computational libraries, they need to be converted to inference models to run on the appropriate target device using a different computing platform and limited set of libraries. These are typically further constrained for resource-limited edge devices having a small set of libraries and running lower-precision computational functions. Hence, apart from a syntactic conversion of the models from training to inference, additional efforts are needed for ensuring model performance. Various conversion tools (e.g., TensorFlow Lite Converter) for converting the trained models to deployable inference models (e.g., FlatBuffer files) for a wide range of target devices and platforms. They also allow some post-training optimization/quantization of the ML models for efficient use of CPU and memory.

The network management tools 216 push new ML models 136 can be pushed to the VSATs 130, 130′ using broadcast mechanism for multicast file downloads. The ML model files can be updated on the VSATs in a fashion similar to updating software configuration settings. This is unlike the software update mechanism where the whole device software is first loaded, and then an update is triggered by rebooting the CPE. A ML model update, like some configuration changes, can be as simple as updating a file. Furthermore, while some configuration changes require a reboot, ML models can be updated without requiring any reboot. One way this can be done is by structuring the terminals 130, 130′ to use an interpreter to run the ML models, rather than hard-coding the model into the software package. Based on the ML model application, the newer set of generated input features will automatically be applied to the updated ML model. However, in some instances, ML model updates may be accompanied with some minor configuration changes to handle differences in how the input features are generated from the user traffic. Only in scenarios when the types of input or output of the model change significantly will there be a minor noticeable impact to the user. Thus our update mechanism causes minimal impact on the user and well as the network system.

It is also possible for the ML model updates to be controlled or adjusted for various reasons. For example, the system 200 can do a gradual, phased rollout using groups of user VSATs 130. This can allow the system 200 (e.g., the server 160 and/or the gateway 110) impact of the new model to be monitored and evaluated. If the impact on client devices and terminals is positive, the distribution can continue. On the other hand, if the impact is negative, the distribution can be paused for further review or to generate a further improved model update. The system 200 can also enable A/B testing to evaluate the utility and impact of update model on overall network resources. With this technique, the server 160 sends different models or different model updates to different groups of terminals 130, to evaluate differences in accuracy and terminal 130 performance that the different models produce. Based on differences in accuracy and traffic flow performance, the server 160 can select from among the multiple model updates tested and distribute the one that has the highest performance generally among the terminals 130.

In the overall system 200, the approach enables automation to a large extent. The system 200 can automate periodic or targeted data collection on real-user VSATs 130 as well as test VSATs 130′ and test devices 140d. Similarly, the system 200 can automate ML model training, using online learning. These trained models can be automatically converted to inference models for the VSAT devices using converter tools like Tensorflow Lite converter. The updated ML models can be automatically pushed to all the VSATs 130, 130′ through a maintenance feature or protocol, such as a file multicast technique. In addition, manual checks or controls can be added to evaluate and further optimize whenever necessary. For example, manual changes can be made for bigger changes to the techniques or types of labelled data collection, or changes to use different ML model architecture, or advanced inference model optimization not easily handled by the automated tools.

In some implementations, the features of the central server 160 for collection, training, and model updates can be divided and distributed or replicated among different systems, if desired. This way, the system 200 can obtain tailored ML models to account for differences in different groups of users. This can be done, for example, to generate different ML models for different satellite gateways, satellite beams, user service tiers, etc. These different models can of course share some useful information across the groups. For example, even though the system 200 might have different ML models for each satellite gateway (e.g., to be used by the terminals 130, 130′ that connect through that gateway), the metadata and log data from one gateway can be used to generate test workflow content to be tested through another gateway system. This can ensure that a broad base of test scenarios (e.g., applications, web sites, data stream types, etc.) are used for each of the different gateways.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
receiving, by the one or more computers, log data from a plurality of devices in a communication network, wherein each of the plurality of devices stores a local copy of a machine learning model and uses the machine learning model to manage network traffic at the device, wherein the log data indicates characteristics of network traffic flows at the respective devices;
training, by the one or more computers, the machine learning model based on the received log data to change parameters of the machine learning model, the machine learning model being trained to predict a network traffic management parameter in response to receiving input indicating characteristics of the network traffic flows; and
broadcasting, by the one or more computers, an update for the machine learning model to the plurality of devices in the communication network, wherein the update is based on the changed parameters of the machine learning model, and wherein the broadcasted update is transmitted to the plurality of devices using a multicast transmission.

2. The method of claim 1, wherein the plurality of devices are satellite terminals in a satellite communication network.

3. The method of claim 1, wherein the broadcasted update includes updated values of model parameters of the machine learning model.

4. The method of claim 3, wherein the broadcasted update includes a full replacement model that comprises values for all of the model parameters of the machine learning model.

5. The method of claim 3, wherein the broadcasted update includes a partial replacement model that comprises updated values for only a subset of model parameters having fewer than all of the model parameters of the machine learning model.

6. The method of claim 1, wherein the broadcasted update is an incremental update that includes incremental values of model parameters of an updated version of the machine learning model compared to a previous version of the machine learning model.

7. The method of claim 1, wherein the update of the machine learning model, upon being received by one or more of the plurality of the devices, enables the one or more of the plurality of the devices to transition from using a previous version of the machine learning model to using an updated version of the machine learning model without interrupting network traffic at the by one or more of the plurality of the devices.

8. The method of claim 1, wherein the broadcasted update is transmitted over a channel assigned to provide software, firmware, or configuration settings to the devices.

9. The method of claim 1, further comprising:
after training the machine learning model based on the received log data, performing an optimization process to reduce complexity of the machine learning model.

10. The method of claim 9, wherein performing the optimization process includes performing the optimization process according to one or more of: properties of the devices, status of the devices, or the characteristics of the network traffic flows.

11. The method of claim 9, wherein performing the optimization process includes one or more of: quantizing parameter values of the machine learning model, truncating the parameter values of the machine learning model, reducing a number of parameters of the machine learning model, or compressing the machine learning model.

12. The method of claim 1, wherein the characteristics of the network traffic flows include network traffic statistics.

13. The method of claim 1, wherein the network traffic management parameter includes one or more of:
a quality of experience (QoE) score for an end user of the communication network at the respective devices;
a classification of quality of service (QoS) levels of the communication network at the respective devices;
a classification of traffic types of the network traffic flows at the respective devices;
an identification of application types using the network traffic flows at the respective devices;
a detection of anomalies in the network traffic flows at the respective devices; or
a determination of network traffic priority scores at the devices.

14. The method of claim 1, further comprising:
periodically broadcasting messages that indicate a version number of a current version of the machine learning model;
receiving, from one of the plurality of devices, a request for the current version of the machine learning model;
in response to receiving the request, scheduling a transmission of the current version of the machine learning model, wherein the transmission is scheduled to occur at least a predetermined amount of time after the request; and
broadcasting the current version of the machine learning model via multicast to the plurality of devices.

15. A system comprising:
one or more computers; and
one or more computer-readable media storing instructions that are operable, when executed by the one or more computers, to cause the one or more computers to perform operations comprising:
receiving, by the one or more computers, log data from a plurality of devices in a communication network, wherein each of the plurality of devices stores a local copy of a machine learning model and uses the machine learning model to manage network traffic at the device, wherein the log data indicates characteristics of network traffic flows at the respective devices;
training, by the one or more computers, the machine learning model based on the received log data to change parameters of the machine learning model, the machine learning model being trained to predict a network traffic management parameter in response to receiving input indicating characteristics of the network traffic flows; and
broadcasting, by the one or more computers, an update for the machine learning model to the plurality of devices in the communication network, wherein the update is based on the changed parameters of the machine learning model, and wherein the broadcasted update is transmitted to the plurality of devices using a multicast transmission.

16. The system of claim 15, wherein the plurality of devices are satellite terminals in a satellite communication network.

17. The system of claim 15, wherein the broadcasted update includes updated values of model parameters of the machine learning model.

18. The system of claim 17, wherein the broadcasted update includes a full replacement model that comprises values for all of the model parameters of the machine learning model.

19. The system of claim 17, wherein the broadcasted update includes a partial replacement model that comprises updated values for only a subset having fewer than all of the model parameters of the machine learning model.

20. One or more non-transitory computer-readable media storing instructions that are operable, when executed by the one or more computers, to cause the one or more computers to perform operations comprising:
receiving, by the one or more computers, log data from a plurality of devices in a communication network, wherein each of the plurality of devices stores a local copy of a machine learning model and uses the machine learning model to manage network traffic at the device, wherein the log data indicates characteristics of network traffic flows at the respective devices;
training, by the one or more computers, the machine learning model based on the received log data to change parameters of the machine learning model, the machine learning model being trained to predict a network traffic management parameter in response to receiving input indicating characteristics of the network traffic flows; and
broadcasting, by the one or more computers, an update for the machine learning model to the plurality of devices in the communication network, wherein the update is based on the changed parameters of the machine learning model, and wherein the broadcasted update is transmitted to the plurality of devices using a multicast transmission.
